(19) United States
(12) Patent Application Publication
(10) Pub. No.: US 2012/0188215 A1
(43) Pub. Date: Jul. 26, 2012

(54) ELECTROMECHANICAL DEVICES WITH VARIABLE MECHANICAL LAYERS

(75) Inventor: Karishma Bushankuchu, San Jose (US)

(73) Assignee: QUALCOMM MEMS TECHNOLOGIES, INC., San Diego, CA (US)

(21) Appl. No.: 13/073,849

(22) Filed: Mar. 28, 2011

Related U.S. Application Data
(60) Provisional application No. 61/435,701, filed on Jan. 24, 2011.

(51) Int. Cl. G06F 3/038; G02B 26/00; B05D 3/10; H02N 11/00

(52) U.S. Cl. 345/211; 310/300; 359/295; 216/13

(57) ABSTRACT

An electromechanical systems array includes a substrate and a plurality of electromechanical systems devices. Each electromechanical systems device includes a stationary electrode, a movable electrode, and an air gap defined between the stationary electrode and the movable electrode, where the air gap defines open and collapsed states. At least two different electromechanical systems device types correspond to finished devices having different sized air gaps when in the open state. Each electromechanical systems device further includes a primary mechanical layer of a common thickness along with one or more mechanical sub-layers with a different cumulative thickness for each of the at least two different electromechanical systems device types. The mechanical sub-layers can be deposited for use as etch stops during processing of the air gap. The different air gap sizes of each electromechanical systems device type can correspond to a different mechanical sub-layer thickness.

### CLAIM OF PRIORITY

This application claims the benefit of U.S. Provisional Patent Application No. 61/435,701, filed Jan. 24, 2011, which is incorporated in its entirety by reference herein.

### TECHNICAL FIELD

This disclosure relates to electromechanical systems arrays with multiple device types of different gap sizes having mechanical layers that differ in material properties.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a metallic membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in an electromechanical system. The system includes a substrate and a plurality of electromechanical devices. Each electromechanical device includes a stationary electrode, a movable electrode, and a collapsible gap. The collapsible gap is defined between the movable electrode and the stationary electrode, and the gap defines at least open and collapsed states. The electromechanical devices further include at least two electromechanical device types having different gap sizes when in the open state. The movable electrode for at least two of the electromechanical device types includes one or more mechanical sub-layers facing the gap. The cumulative thickness of the mechanical sub-layer(s) is a different thickness for each of the at least two electromechanical device types.

In some implementations, the one or more mechanical sub-layers of each of the at least two electromechanical device types can include one or more etch stop layers. Furthermore, the stationary electrode of each of the at least two electromechanical device types can include one or more optical layers facing the gap, the cumulative thickness of the optical layers being different for each of the at least two electromechanical device types.

Another innovative aspect can be implemented in a method of manufacturing at least a first electromechanical device, a second electromechanical device, and a third electromechanical device in first, second, and third regions, respectively. The method includes providing a substrate, forming a stationary electrode layer over the substrate; forming a first sacrificial layer over the stationary electrode layer in the first region, forming a first stiffening layer over the first sacrificial layer in the first region, and forming a second sacrificial layer over the stationary electrode layer in the second region. The second sacrificial layer has a different thickness than that of the first sacrificial layer. The method further includes forming a second stiffening layer over the first stiffening layer in the first region and over the second sacrificial layer in the second region. The method further includes forming a third sacrificial layer over the stationary electrode layer in the third region. The third sacrificial layer has a different thickness than that of the first and second sacrificial layers. The method further includes forming a movable electrode layer over the first, second and third sacrificial layers, respectively.

In some implementations, at least one electromechanical device type can be configured to not have a mechanical sub-layer. Furthermore, the at least two electromechanical device types can include an interferometric modulator configured to reflect red light when in the open state, an interferometric modulator configured to reflect blue light when in the open state, and an interferometric modulator configured to reflect green light when in the open state. The method can further include forming a second stiffening layer over the first stiffening layer in the first region and over the second sacrificial layer in the second region. The method can further include forming a third sacrificial layer over the stationary electrode layer in a third region, the third sacrificial layer having a different thickness than that of the first and second sacrificial layers. Furthermore, forming the movable electrode layer further can include forming the movable electrode layer over the third sacrificial layer. Forming the movable electrode layer can include forming the movable electrode layer on the second stiffening layer in the first region. The movable electrode layer, the first stiffening layer, and the second stiffening layer can form a first mechanical layer in the first region. Forming the movable electrode layer can further include forming the movable electrode layer on the second stiffening layer in the second region. The movable electrode layer and the second stiffening layer can form a second mechanical layer in the second region. Forming the movable electrode layer can further include forming the movable electrode layer on the third sacrificial layer in the third region. The movable electrode layer can form a third mechanical layer in the third region.

Another innovative aspect can be implemented in an electromechanical system including at least a first electromechanical device and a second electromechanical device. The electromechanical system further includes means for supporting the first and second electromechanical devices, means for defining a first gap for the first electromechanical device, and means for defining a second gap for the second electromechanical device. The second gap has a different size than the first gap. The system further includes means for selectively collapsing and opening the first gap for the first electromechanical device, means for selectively collapsing and opening the second gap for the second electromechanical device, and first stiffening means for stiffening the means for selectively collapsing and opening the first gap. The first stiffening means faces the first gap. The system further includes second stiffening means for stiffening the means for selectively collapsing and opening the second gap. The second stiffening means faces the second gap and provides a different stiffness from the first stiffening means.

In some implementations, the electromechanical system can further include a first etch stop means on the first electrode of the means for selectively collapsing and opening the first gap and a second etch stop means on the first electrode of the means for selectively collapsing and opening the second gap. The first electrode of the means for selectively collapsing and opening the first gap can be positioned under the second electrode of the means for selectively collapsing and opening the first gap. The first electrode of the means for selectively collapsing and opening the second gap can be positioned under the second electrode of the means for selectively collapsing and opening the second gap.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3A shows an example of a diagram illustrating movable reflective layer position versus applied voltage for the interferometric modulator of FIG. 1.

FIG. 3B shows an example of a table illustrating various states of an interferometric modulator when various common and segment voltages are applied.

FIG. 4A shows an example of a diagram illustrating a frame of display data in the 3×3 interferometric modulator display of FIG. 2.

FIG. 4B shows an example of a timing diagram for common and segment signals that may be used to write the frame of display data illustrated in FIG. 4A.

FIG. 5A shows an example of a partial cross-section of the interferometric modulator display of FIG. 1.

FIGS. 5B-5E show examples of cross-sections of varying implementations of interferometric modulators.

FIG. 6 shows an example of a flow diagram illustrating a manufacturing process for an interferometric modulator.

FIGS. 7A-7E show examples of cross-sectional schematic illustrations of various stages in a method of making an interferometric modulator.

FIG. 8A shows an example of a schematic cross-section of three different electromechanical device types with all three shown in the open state having different sized air gaps and stiffening layers of different thickness.

FIG. 8B shows an example of a schematic cross-section of the devices of FIG. 8A in the collapsed state.

FIGS. 9A-9H show examples of schematic cross-sections illustrating an electromechanical device fabrication process including etch stops that remain as part of the electromechanical device.

FIG. 10A shows an example of a schematic cross-section of two different electromechanical device types with both shown in the open state having different sized air gaps and stiffening layers of different thickness.

FIG. 10B shows an example of a schematic cross-section of the devices of FIG. 10A in the collapsed state.

FIGS. 11A-11F show examples of schematic cross-sections illustrating an electromechanical device fabrication process including etch stops that remain as part of the electromechanical device, for two different electromechanical device types.

FIG. 12 shows an example of a flow chart illustrating a process of fabricating different electromechanical device types with different sacrificial layer thicknesses.

FIGS. 13A and 13B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to a person having ordinary skill in the art.

An array of electromechanical systems devices can be implemented to have at least two different electromechanical device types, such as different interferometric modulator types corresponding to different reflected colors. Each different device type can have a different sized air gap. Each different device type can have a mechanical sub-layer with a different thickness. The mechanical sub-layers can be deposited for use as etch stops for patterning sacrificial layers to define the different air gaps, and can remain as part of a movable electrode after removal of the sacrificial layers.

Particular implementations of the subject matter described in this disclosure can be implemented to realize one or more of the following potential advantages. The different thicknesses of the mechanical sub-layer can allow an array of electromechanical systems devices to use a normalized actuation voltage. Normalization of the actuation voltage can reduce the complexity, and therefore the cost, of driving circuitry. Furthermore, an array of electromechanical systems devices as described herein can be constructed with minimal masking processes. Multiple masks may be employed to define the different sacrificial layer thicknesses that ultimately result in different electromechanical systems device gap sizes. However, the processes described here allow simultaneous definition of multiple mechanical layer thicknesses without additional mask processes. Using fewer masks can further reduce the cost of production and increase yield.

One example of a suitable electromechanical systems device, e.g., a MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths, allowing for a color display in addition to black and white.

The IMOD display device can include a row/column array of IMODs. Each IMOD can include a pair of reflective layers, particularly a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16, which serves as or includes the stationary electrode for the illustrated IMOD implementation. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14 back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by a person having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 microns (μm), while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

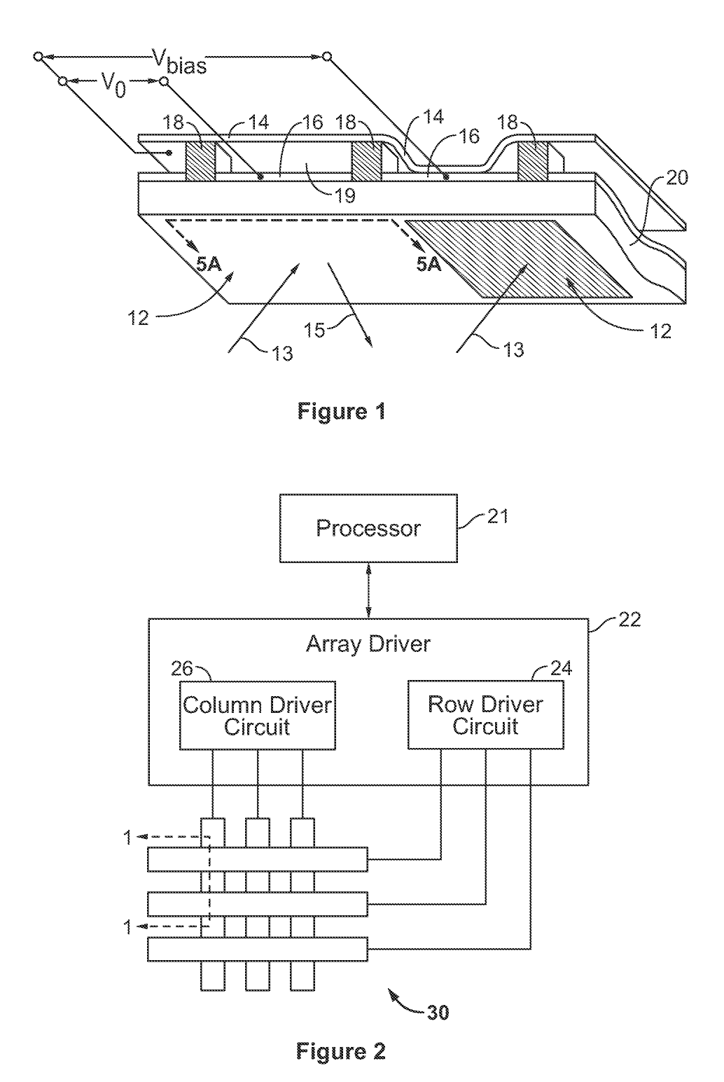

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

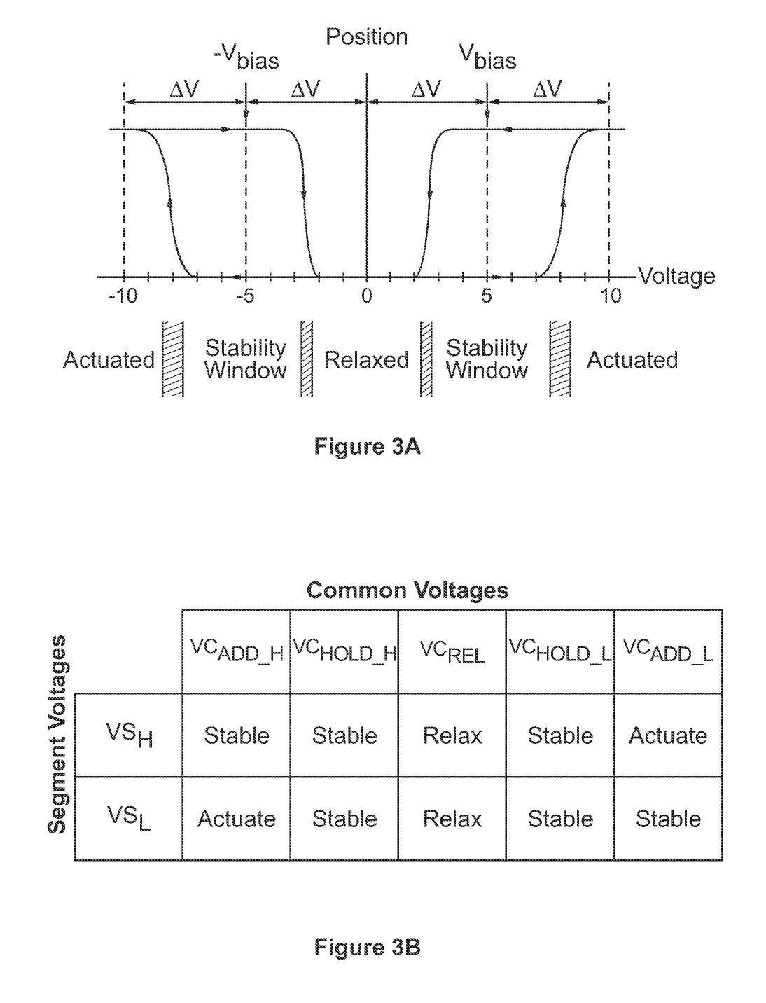

FIG. 3A shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3A. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts; however, the movable reflective layer does not relax completely until the voltage drops below 2-volts. Thus, a range of voltage, approximately 3 to 7-volts, as shown in FIG. 3A, exists where there is a window of applied voltage within which the device is stable in either the relaxed or actuated state. This is referred to herein as the “hysteresis window” or “stability window.” For a display array 30 having the hysteresis characteristics of FIG. 3A, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 3B shows an example of a table illustrating various states of an interferometric modulator when various common and segment voltages are applied. As will be readily understood by a person having ordinary skill in the art, the “segment” voltages can be applied to either the column electrodes or the row electrodes, and the “common” voltages can be applied to the other of the column electrodes or the row electrodes.

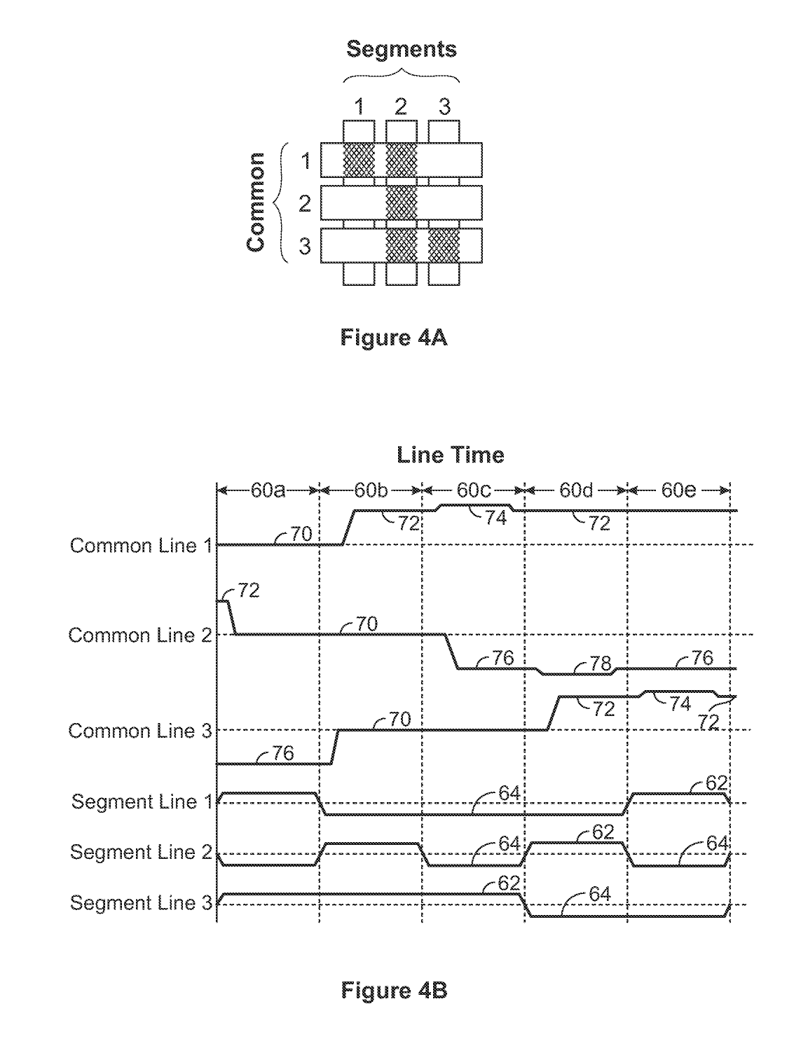

As illustrated in FIG. 3B (as well as in the timing diagram shown in FIG. 4B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3A, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 4A shows an example of a diagram illustrating a frame of display data in the 3×3 interferometric modulator display of FIG. 2. FIG. 4B shows an example of a timing diagram for common and segment signals that may be used to write the frame of display data illustrated in FIG. 4A. The signals can be applied to the, e.g., 3×3 array of FIG. 2, which will ultimately result in the line time 60e display arrangement illustrated in FIG. 4A. The actuated modulators in FIG. 4A are in a dark-state, i.e., where a substantial portion of the reflected light is outside of the visible spectrum so as to result in a dark appearance to, e.g., a viewer. Prior to writing the frame illustrated in FIG. 4A, the pixels can be in any state, but the write procedure illustrated in the timing diagram of FIG. 4B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 3B, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 4A, and will remain in that state as long as the hold voltages are applied along the common lines, regardless of variations in the segment voltage which may occur when modulators along other common lines (not shown) are being addressed.

In the timing diagram of FIG. 4B, a given write procedure (e.g., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 4B. In some other implementations, voltages applied along common lines or segment lines may vary to account for variations in the actuation and release voltages of different modulators, such as modulators of different colors.

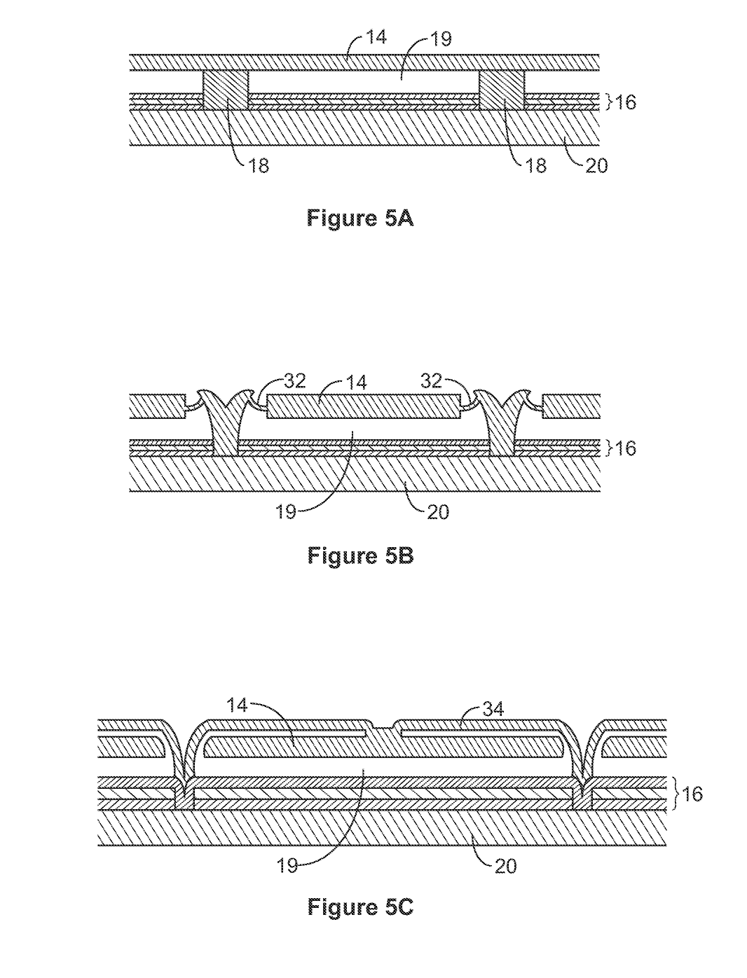

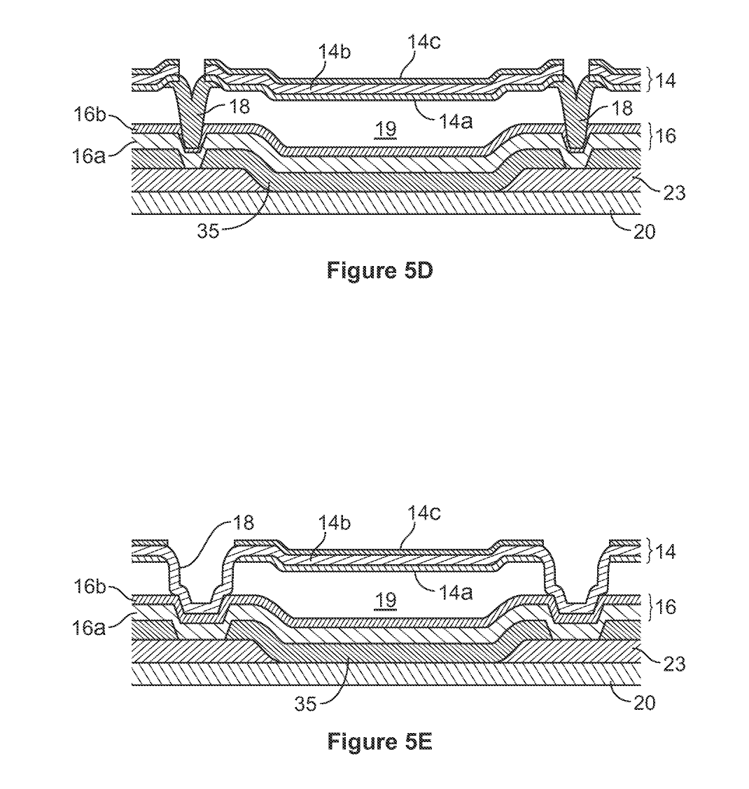

The details of the structure of interferometric modulators that operate in accordance with the principles set forth above may vary widely. For example, FIGS. 5A-5E show examples of cross-sections of varying implementations of interferometric modulators, including the movable reflective layer 14 and its supporting structures. FIG. 5A shows an example of a partial cross-section of the interferometric modulator display of FIG. 1, where a strip of metal material, i.e., the movable reflective layer 14 is deposited on supports 18 extending orthogonally from the substrate 20. In FIG. 5B, the movable reflective layer 14 of each IMOD is generally square or rectangular in shape and attached to supports at or near the corners, on tethers 32. In FIG. 5C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 5C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 5D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (e.g., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an Al alloy with about 0.5% Cu, or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 5D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can include conductor(s) and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with thicknesses in the range of about 30-80 Å, 500-1000 Å, and 500-6000 Å, respectively. The one or more layers can be patterned using a variety of techniques, including photolithography and dry etching, including, for example, CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 5E shows another example of an IMOD, where the movable reflective layer 14 is self supporting. In contrast with FIG. 5D, the implementation of FIG. 5E does not include separate materials for the support posts 18. Instead, at least a portion of the movable reflective layer 14 contacts the underlying optical stack 16 at multiple locations, and the curvature of the movable reflective layer 14 provides sufficient support that the movable reflective layer 14 returns to the unactuated position of FIG. 5E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 5A-5E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 5C) can be configured and operated upon without impacting or negatively affecting the image quality of the display device, because the reflective layer 14 optically shields those portions of the device. For example, in some implementations a bus structure (not illustrated) can be included behind the movable reflective layer 14, which provides the ability to separate the optical properties of the modulator from the electromechanical properties of the modulator, such as voltage addressing and the movements that result from such addressing. Additionally, the implementations of FIGS. 5A-5E can simplify processing, such as, e.g., patterning.

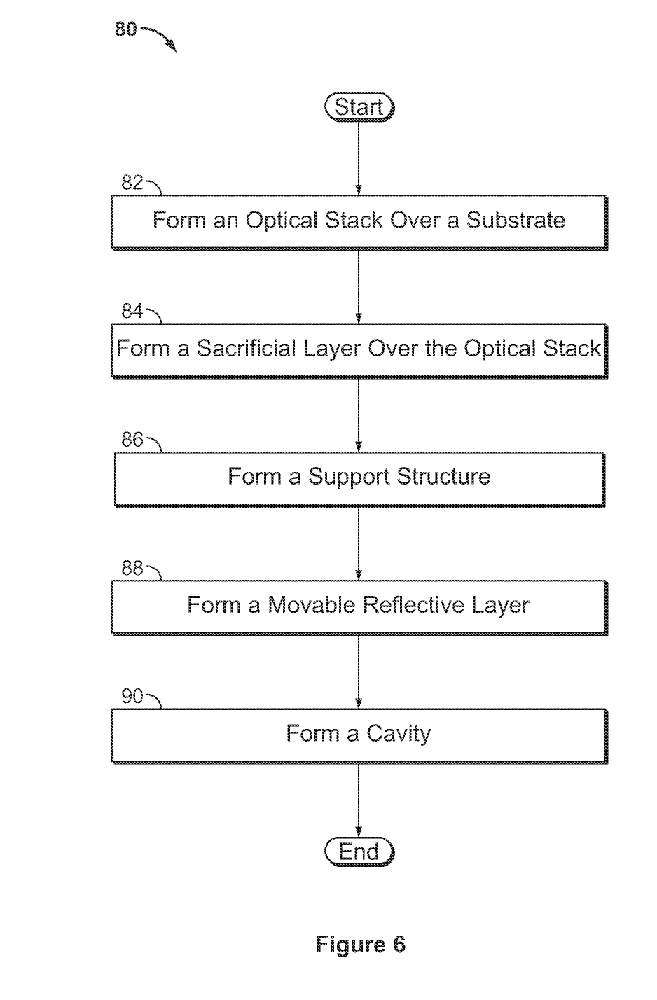

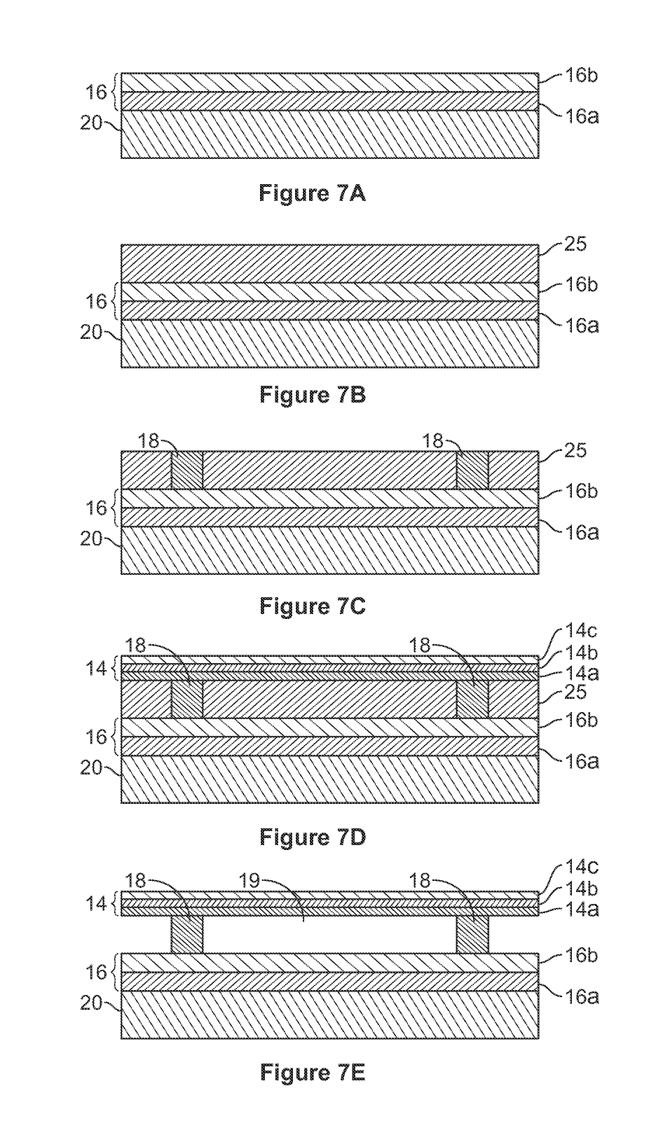

FIG. 6 shows an example of a flow diagram illustrating a manufacturing process 80 for an interferometric modulator, and FIGS. 7A-7E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 5A-5E, in addition to other blocks not shown in FIG. 6. With reference to FIGS. 1, 5A-5E and 6, the process 80 begins at block 82 with the formation of the optical stack 16 over the substrate 20. FIG. 7A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 7A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 (FIG. 7E) and thus the sacrificial layer 25 is not shown in the resulting interferometric modulators 12 illustrated in FIG. 1. FIG. 7B illustrates a partially fabricated device including a sacrificial layer 25 formed over the optical stack 16. The formation of the sacrificial layer 25 over the optical stack 16 may include deposition of a fluorine-etchable material such as molybdenum (Mo) or amorphous silicon (Si), in a thickness selected to provide, after subsequent removal, a gap or cavity 19 (see also FIGS. 1 and 7E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 5A-5E and 7C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 5A. Alternatively, as depicted in FIG. 7C, the aperture formed in the sacrificial layer 25 can extend through the sacrificial layer 25, but not through the optical stack 16. For example, FIG. 7E illustrates the lower ends of the support posts 18 in contact with an upper surface of the optical stack 16. In other arrangements, the support posts can land on a black mask structure. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 7C, but also can, at least partially, extend over a portion of the sacrificial layer 25. As noted above, the patterning of the sacrificial layer 25 and/or the support posts 18 can be performed by masking and etching processes, but also may be performed by alternative patterning methods.

The process 80 continues at block 88 with the formation of a movable reflective layer or membrane such as the movable reflective layer 14 illustrated in FIGS. 1, 5A-5E and 7D. The movable reflective layer 14 may be formed by employing one or more depositions, e.g., reflective layer (e.g., aluminum, aluminum alloy) deposition, along with one or more patterning, masking, and/or etching processes. The movable reflective layer 14 can be electrically conductive, and referred to as an electrically conductive layer. In some implementations, the movable reflective layer 14 may include a plurality of sub-layers 14a, 14b, 14c as shown in FIG. 7D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 5 and 7E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

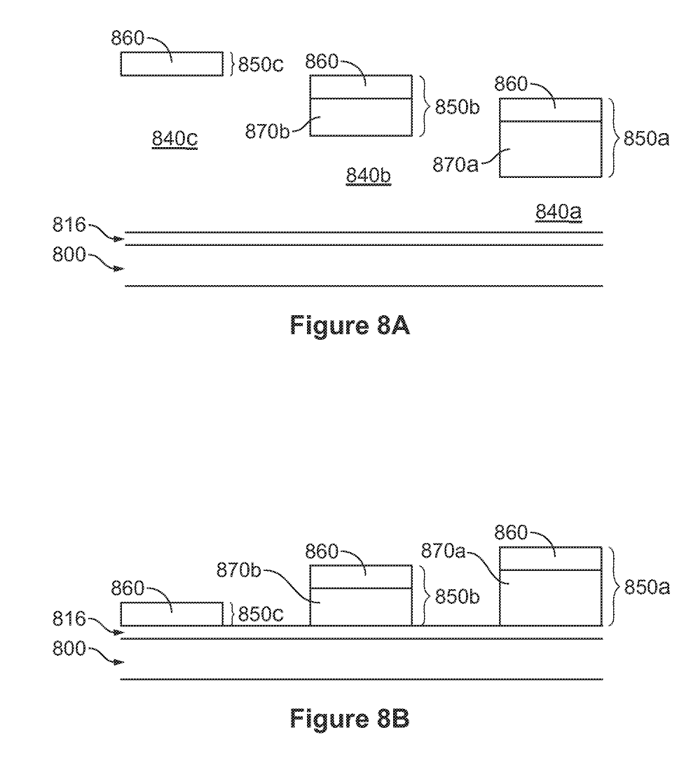

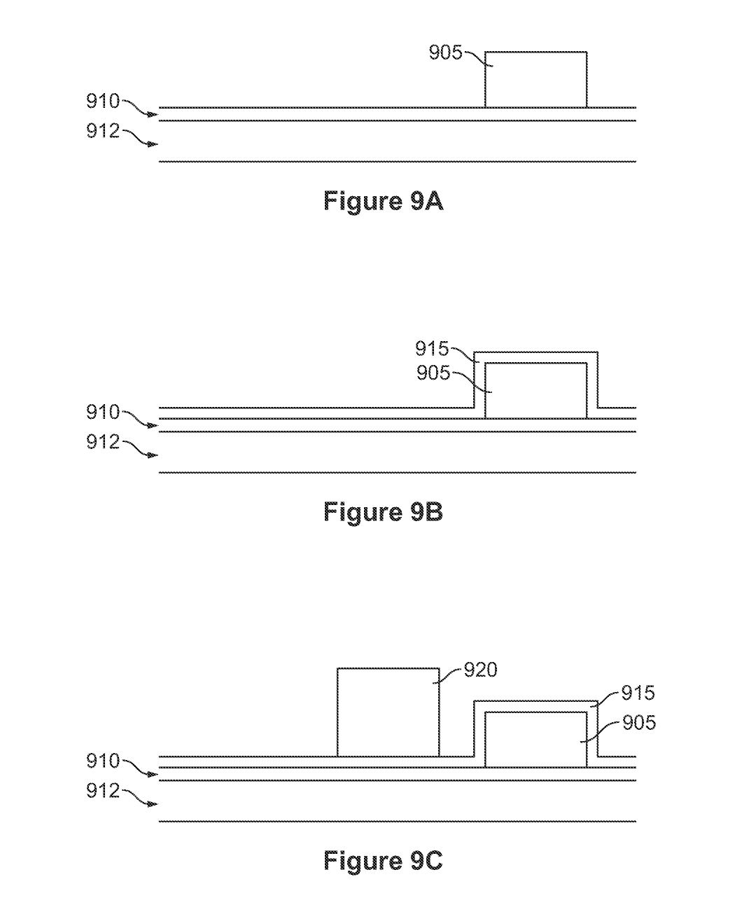

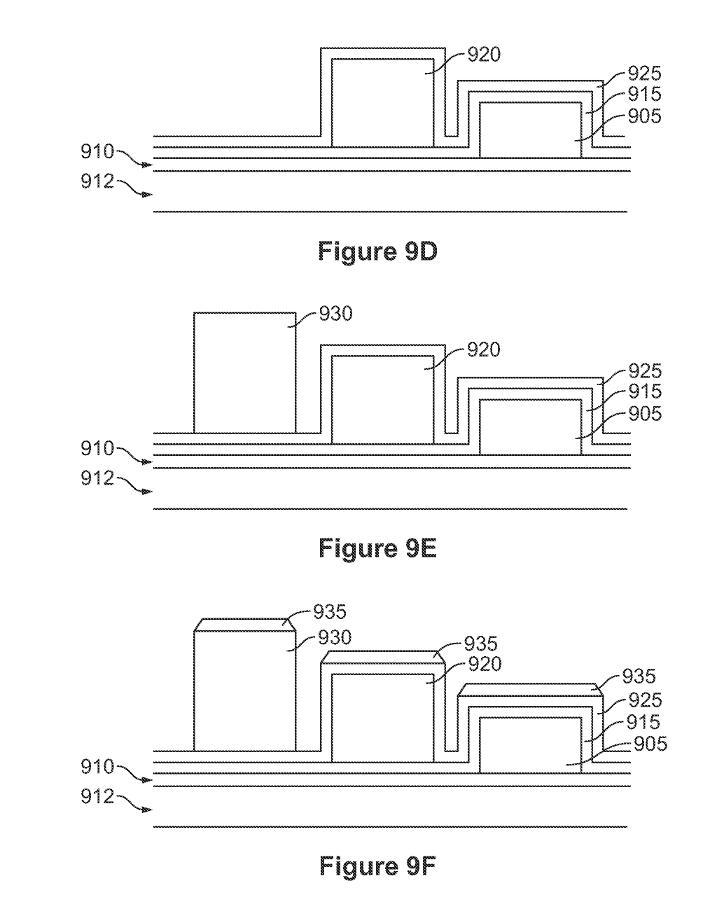

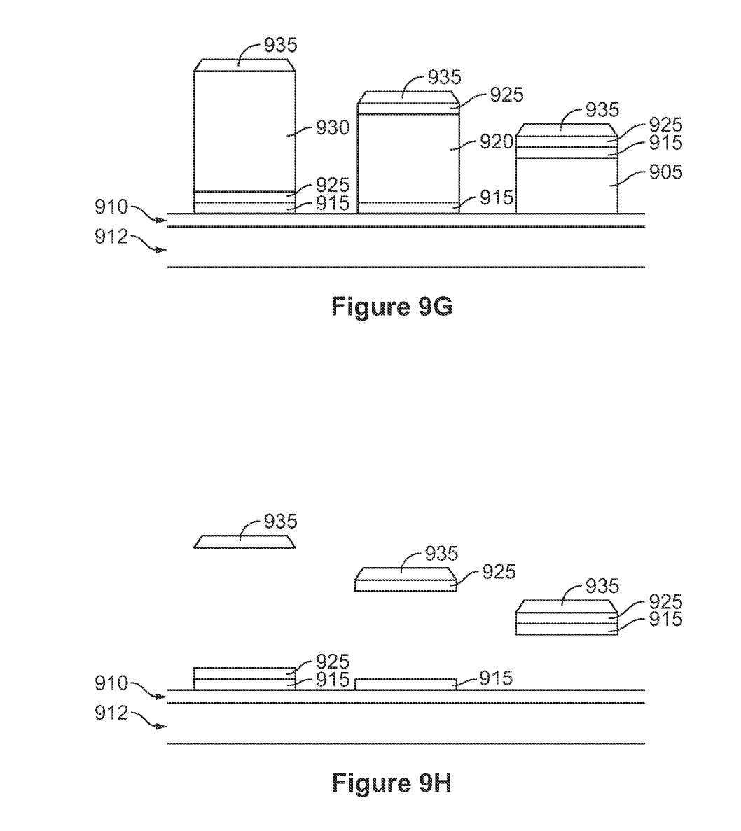

The illustrated electromechanical systems devices are optical MEMS devices referred to as interferometric modulators (IMODs). IMODs may be manufactured using manufacturing techniques known in the art for making electromechanical devices. For example, the various material layers making up the IMODs may be sequentially deposited onto a transparent substrate with appropriate patterning and etching processes conducted between depositions. In some implementations, multiple layers may be deposited during manufacturing without patterning between the depositions. For example, the movable reflective layer described above may include a composite structure having two or more layers. While illustrated in the context of optical electromechanical devices, particularly IMODs, a skilled artisan will readily appreciate that the concepts of this disclosure can be applicable to other electromechanical devices, such as RF switches, gyroscopes, varactors, etc. The principles and advantages of the structures and sequences described for FIGS. 8A-9H are readily applicable to non-optical electromechanical systems devices, particularly for arrays with multiple gap sizes.

Color interferometric modulator (IMOD) display systems typically involve arrays of electromechanical devices, in which each electromechanical device has one of two or more different air gap sizes where each air gap size can display a color. In one implementation, each of three different air gap sizes can display red, green, and blue, respectively. In particular, an electromechanical pixel represents a pixel in a color display, where each pixel typically includes three IMOD types or subpixels. Hereinafter, certain implementation examples will be described for different interferometric electromechanical architectures.

FIGS. 8A and 8B illustrate one implementation of an electromechanical device array having three different electromechanical device types, each with a different gap size. FIG. 8A illustrates the devices in the open state, while FIG. 8B illustrates the devices in the collapsed state. While it is possible for electromechanical devices to have more than two states with differing gap sizes in the different states, the presently described implementations assume two-state devices, fully open or fully closed, such that references to “gap size” herein refer to the maximum gap size in the fully open state.

FIG. 8A shows an example of a schematic cross-section of three different electromechanical device types with all three shown in the open state having different sized air gaps and stiffening layers of different thickness. In the illustrated implementation, an electromechanical system device includes a substrate 800 on which at least three different types of electromechanical systems device structures are formed. In one implementation, each of the at least three different types of electromechanical structures can be IMOD devices configured to reflect a different color in one of the states. The different electromechanical device types each include a stationary electrode 816. The stationary electrode 816 is formed on the substrate 800 and may not be of a uniform thickness between electromechanical structures of different types. In an IMOD implementation, the stationary electrode 816 can form part of an optical stack, as described above, and the movable electrodes 850a and 850b can each include a primary mechanical layer 860 and a mechanical sub-layer 870a and 870b, respectively. In an IMOD implementation, the mechanical layers 860 can include a movable reflective layer (not shown). Each of the at least three different types of electromechanical structures can have a mechanical sub-layer 870 of different thickness. In the illustrated implementation, the mechanical sub-layer is absent from one type of electromechanical structure. As mentioned above, the electromechanical structures include the movable electrodes 850a, 850b and 850c above the stationary electrode 816, and also include the air gaps 840a, 840b and 840c formed between the movable electrodes 850a, 850b and 850c and the stationary electrode 816. A person having ordinary skill in the art will readily understand that the figures are simplified schematics and additional layers, such as underlying or intervening buffer layers, black mask layers, and bussing layers, may be present.

The movable electrodes 850a, 850b and 850c can be configured to serve as the moving or upper electrodes for the electromechanical devices, and can take any of a number of forms (see, e.g., FIGS. 5A-5E). The stationary electrode 816 can include one or more conductors and can serve as the lower electrode of the electromechanical device. The stationary electrode 816 can be patterned in rows that cross with columns formed by mechanical layer strips to electrically address different electromechanical devices (e.g., pixels) in an array.

In FIG. 8A, the electromechanical system includes three electromechanical structures each having different sized air gaps 840a, 840b and 840c. The air gaps 840a, 840b and 840c can be formed by depositing sacrificial material between the upper and lower electrodes, and subsequent removal of the sacrificial material from between the electrodes by “release” etching. A vapor phase etchant for the release can be a fluorine-based etchant, such as XeF₂, and the sacrificial layer may be formed, e.g., of Mo, amorphous Si, W, or Ti for selective removal by F-based etchants relative to surrounding structural materials. For example, the sacrificial layer can be removed using H₂SiF₆ as an etchant.

Furthermore, the movable electrodes 850a, 850b and 850c can vary in size between the three different electromechanical device types. The difference in size between the movable electrodes 850a, 850b and 850c can be due to a difference in thickness of the mechanical sub-layers 870a and 870b. The absence of a mechanical sub-layer constitutes a thickness of zero for the purpose of distinguishing between different device types. The difference in thickness among the movable electrodes 850a, 850b and 850c can cause the movable electrodes 850a, 850b and 850c to have different stiffnesses. In the illustrated implementation, the different thicknesses of the movable electrodes 850a, 850b and 850c inversely corresponds to the sizes of the air gaps 840a, 840b and 840c. Because devices with relatively larger air gaps, such as the air gap 840c, deform farther in order to transition to the collapsed state, a greater actuation voltage may be appropriate. By varying the thickness of the movable electrodes 850a, 850b and 850c such that devices with a larger air gap 840a, 840b and 840c have a relatively lower stiffness, the actuation voltages appropriate for transitioning the devices into the collapsed state can be normalized. This effect can allow an electromechanical device driver to use the same voltages to collapse or relax (e.g., with bias) different electromechanical device types having different air gap sizes.

FIG. 8B shows an example of a schematic cross-section of the devices of FIG. 8A in the collapsed state. As shown in the illustrated implementation, air gaps 840a, 840b and 840c are no longer present when the electromechanical devices are in the collapsed or actuated state. While all three electromechanical device types are shown in the collapsed state, a person having ordinary skill in the art will readily understand that the air gaps 840a, 840b and 840c can be independently opened and collapsed in any combination.

Typically, electromechanical systems device structures use multiple sacrificial layers with different thicknesses and/or complex masking sequences to produce multiple air gap sizes. Some exemplary methods of fabricating air gaps of different sizes are described in U.S. Pat. No. 7,297,471 and U.S. Pat. Pub. No. 2007/0269748. A person having ordinary skill in the art will readily appreciate that producing air gap layers of different sizes requires multiple depositions, multiple masks, and multiple etchings, and that multiple patterning processes increase costs and give rise to etch attack issues. However, the number of patterning processes can be reduced by sequencing the deposition of sacrificial layers and use of etch stop layers. Furthermore, processes described herein allow the etch stop layers to ultimately become part of the movable electrode, the stationary electrode, or both. Etch stop layers that ultimately become part of the electromechanical device can be referred to generally as solid layers or stiffening layers. The sequence in which multiple solid layers are used can cause the thicknesses of the movable electrode to vary between the two or more electromechanical devices. Because each solid layer can be used both as an etch stop during processing of sacrificial layers and as part of the movable electrode in the final device, serving the additional function of providing different mechanical layer stiffnesses for different device types, fewer total processes are needed. For example, the process of making three different sacrificial layer thicknesses also can result in three different movable electrode thicknesses using the same masks, with each electromechanical device accumulating a different number of solid layers above the respective sacrificial layer. Thus, each movable electrode also can acquire a different stiffness as a result of the different thicknesses. Similarly, in implementations where the electromechanical devices are IMODs, any etch stop layers kept in the device, either above or below the air gap, can partially define the optical cavity.

FIGS. 9A-9H show examples of schematic cross-sections illustrating an electromechanical device fabrication process including etch stops that remain as part of the electromechanical device. In the illustrated sequence, three different types of electromechanical systems structures are formed, each having a different size air gap and different movable electrode thicknesses. This implementation is suitable, for example, for producing an IMOD display in which devices with different air gap sizes represent different colors for sub-pixels of a color display.

Referring to FIG. 9A, a first sacrificial layer 905 is formed over a stationary electrode 910 over a substrate 912. The first sacrificial layer 905 can be formed by techniques known in the art, for example, blanket deposition followed by masking, patterning, and etching (e.g., photolithographic patterning). In an IMOD implementation, the height of the first sacrificial layer 905 can correspond to the size of the air gap suitable for the electromechanical structure to display a desired color when in the open state (see chart below). In the illustrated example, the first sacrificial layer 905 has a height corresponding to interferometrically enhanced reflection of the color blue in the completed device. A person having ordinary skill in the art will readily understand that the figures are simplified schematics and additional layers, such as underlying or intervening buffer layers, black mask layers, and bussing layers, may be present. For example, the stationary electrode 910 can include multiple layers. The stationary electrode 910 can optionally include a transparent conductor. The dielectric layer or layers over the conductors can serve as both an insulator to prevent the electrodes from shorting during operation and an etch stop during patterning of the first sacrificial layer.

Referring to FIG. 9B, a first stiffening layer 915 over the first sacrificial layer 905 is deposited over the stationary electrode 910. For the illustrated implementation, the first stiffening layer 915 includes a material that is also suitable as an etch stop for patterning of a sacrificial layer. For implementations where the electromechanical device is an IMOD, the first stiffening layer 915 will ultimately become part of the optical cavity. Accordingly, it can include a material that is suitably transparent. For example, the first stiffening layer 915 can include a material such as AlOₓ. Alternatively, the first stiffening layer 915 can include any material that can act as an etch stop for the first sacrificial layer 905. Specifically, a person having ordinary skill in the art will readily recognize that the first stiffening layer 915 can be any material that is resistant to the etchant and release chemistry used to pattern the sacrificial layer 905, such as, e.g., silicon oxide (SiO₂), silicon nitride (Si₃N₄), silicon oxynitride (SiON), etc. In some implementations, the first stiffening layer 915 can be between about 30 Å and about 250 Å thick. For example, the first stiffening layer 915 can be between about 80 Å and about 200 Å thick, or more particularly about 90-100 Å thick. The first stiffening layer 915 can be deposited using, for example, a PVD sputtering method, CVD, ALD, or other suitable deposition techniques.

Referring to FIG. 9C, subsequently, a second sacrificial layer 920 is formed over the first stiffening layer 915. The second sacrificial layer 920 can be deposited and patterned using techniques and materials similar to those of the first sacrificial layer 905. During the patterning, and more particularly during etching of the sacrificial material with the second mask (not shown) in place, the first stiffening layer 915 serves as an etch stop to protect the first sacrificial layer 905 and the underlying stationary electrode 910. In the illustrated example, the second sacrificial layer 920 has a height corresponding to an interferometrically enhanced reflection of the color green in the completed device.

Referring now to FIG. 9D, a second stiffening layer 925 is deposited over the second sacrificial layer 920 and over the first stiffening layer 915. The second stiffening layer 925 can be deposited using techniques and materials similar to those of the first stiffening layer 915. Next, in FIG. 9E, a third sacrificial layer 930 is formed over the second stiffening layer 925. The third sacrificial layer 930 can be deposited and patterned using techniques and materials similar to those of the first and second sacrificial layers 905 and 920. During the patterning, the second stiffening layer 925 serves as an etch stop to protect the second sacrificial layer 920 from the etchant used for patterning. In the illustrated example, the third sacrificial layer 930 has a height corresponding to an interferometrically enhanced reflection of the color red in the completed device.

Subsequently, in FIG. 9F, a primary mechanical layer 935 is formed over each of the three electromechanical structures. The primary mechanical layer 935 can be formed by techniques known in the art, for example, blanket deposition followed by masking, patterning, and etching. In some implementations, the primary mechanical layer 935 can include multiple layers such as, for example, a SiON layer sandwiched between AlCu layers (see, e.g., FIG. 5D and attendant descriptions). In implementations that include stiffening layers 915 and 925, such as the illustrated implementation, the SiON layer can be substantially uniform. Thus, in the illustrated implementation, a difference in stiffness between different device types, corresponding to different gap sizes, is created by the inclusion of a different number of stiffening layers 915 and 925 rather than a difference in the thickness of the primary mechanical layer 935. This allows fewer processes to be used in the creation of the primary mechanical layer 935, and no additional masks are employed by blanket stiffening layers 915 and 925. In some implementations, the SiON layer is between about 600 Å and about 1000 Å thick. For example, the SiON layer can be between about 700 Å and about 900 Å thick, or more specifically about 800 Å thick. An example to demonstrate the correspondence of stiffening layer thickness to air gap size is shown in the below Table A. Table A also shows an exemplary relationship between interferometric color and air gap size for implementations where the electromechanical device is an IMOD.

TABLE A

| | Example | Example of | | |
|---|---|---|---|---|
| | of Primary | Cumulative | Example | Operational |
| | Mechanical | Stiffening | of | Gap Range |
| Interferometric | Layer | Layer | Sac | in the |
| Color | Thickness | Thickness | Thickness | Open State |
| 2^{nd} Order Blue | 800 Å | 0 Å | 3200 Å | 3100-−3900 Å |
| 1^{st} Order Red | 800 Å | 1500 Å | 2400 Å | 2300-2700 Å |
| 1^{st} Order Green | 800 Å | 2800 Å | 1800 Å | 1700-1900 Å |

Referring now to FIG. 9G, sidewall portions of the sacrificial layers 905, 920, and 930 and the stiffening layers 915 and 925 are removed from the areas between the three electromechanical structures. The stiffening layers 915 and 925 can be removed using, e.g., sputter etching or reactive ion etching (ME). Horizontal portions of the stiffening layers are protected under the primary mechanical layer, and portions between devices and the sidewalls of the sacrificial layers 905, 920, and 930 are removed, exposing the sacrificial layer sidewalls for the subsequent “release etch” that opens the air gaps. Not shown are the support structures (e.g., posts) that will hold up the moving electrodes.

Subsequently, in FIG. 9H, the sacrificial layers 905, 920 and 930 are selectively removed using the aforementioned release etch. Within the electromechanical structures, the stiffening layers 915 and 925 remain in place, becoming part of a movable electrode (such as the movable electrodes 850a, 850b and 850c described above with respect to FIG. 8), the stationary electrode 910, or both. Where the stiffening layers 915 and 925 remain in place, the stiffening layers may be considered part of the stationary electrode 910. In an IMOD implementation, the stiffening layers 915, 925 can be considered part of the optical stack, may be referred to as optical layers, and partially define the optical path length in both open (relaxed) and closed (actuated) states. In electromechanical structures where one or more stiffening layers 915 and 925 combine with the primary mechanical layer 935, the combination becomes stiffer and more resistant to deformation. Therefore, for the same magnitude of actuation voltage applied across the electrodes 910 and 935, a stiffer mechanical layer will deflect a smaller distance. This effect may allow an electromechanical driver to use similar voltages to collapse or relax (e.g., with bias) different electromechanical types having different air gap sizes.

Furthermore, while a different number of stiffening layers 915 and 925 are incorporated into the movable electrodes 935 of the three different electromechanical types, the total number of stiffening layers 915 and 925 between the stationary electrode 910 and the movable electrode 935 remains constant among the three different electromechanical types. Therefore, the optical and physical distance between the stationary electrode 910 and the movable electrode 935 will be approximately constant among different electromechanical types when they are in the collapsed state. In implementations where the electromechanical devices are IMODs, having a constant optical distance between the stationary electrode 910 and the movable electrode 935 in the collapsed state simplifies design of the optical stack because the same materials can be used for each of the three different electromechanical types and the same appearance (e.g., black or white) will be generated in the collapsed or actuated state. Note that the dielectric stack in the collapsed state will generally include a common dielectric across the stationary electrode 910 that is not separately illustrated.

A person having ordinary skill in the art will readily understand that additional or fewer stiffening layers can be used to adjust the gap between the stationary electrode 910 and the movable electrode 935 when in the collapsed or actuated state. Similarly, the relative and absolute thicknesses of the stiffening layers 915 and 925 can be adjusted in order to modify the relative and absolute stiffnesses of the resulting movable electrode stacks. For example, in order to increase the overall actuation voltage, the absolute thickness can be increased by introducing additional stiffening layers to the stiffening layers 915 and 925. Alternatively, individual ones of the stiffening layers 915 and 925 can be made thicker. On the other hand, in order to adjust the relative actuation voltage between different electromechanical device types (for example, to normalize actuation voltage), the stiffening layers 915 and 925 can be made with different relative thicknesses. Because each electromechanical device type has a movable electrode 935 supported by a different combination of stiffening layers, an increase in the thickness of one stiffening layer will only increase the actuation voltage of a subset of electromechanical devices in the array.

A person having ordinary skill in the art will also readily understand that, in implementations where the electromechanical devices are IMODs, the size of an optical cavity does not necessarily equal the thicknesses of the respective sacrificial layer plus the cumulative thickness of the stiffening layers 915 and 925. Rather, after the sacrificial layers 905,920, and 930 are etched away, also referred to as released, such that the movable electrodes 935 are free to move, the movable electrodes 935 tend to respond to competing forces. First, the movable electrodes 935 may tend to move away from the stationary electrode 910 upon release due to inherent stresses in the mechanical layer, thereby increasing the size of the optical cavity. This behavior is known as a “launch effect” or producing a “launch angle.” The operational bias voltage of the MEMS device in a relaxed state typically counteracts the launch angle by moving the movable electrodes 935 towards the stationary electrode 910, thereby decreasing the optical cavity size. The net result is that the absolute size of the optical cavity (which includes the air gap and any transparent layers between the reflective surfaces of the two electrodes) is approximately 10-15% smaller than the thickness of the sum of the sacrificial layers and any etch stop layers.

As seen in Table A above, the air gap of a first electromechanical device is formed by the removal of the first sacrificial layer, which is about 1800 Å thick. When the sacrificial layer is etched and the overlying mechanical layer is freed by release etching the sacrificial layer, the resulting gap size reduces by about 10-15% due to a combination of the “launch angle” caused by stress in the mechanical layer (tending to increase the cavity size) and the operational voltage that draws the upper electrode closer to the lower electrode even in the “relaxed” position (tending to decrease the cavity size). This results in an electromechanical device having a second order blue color, with an air gap range about 310 nm and 390 nm, in the open or relaxed state. The air gaps for the second and third electromechanical devices are described in a similar fashion according to the chart above.

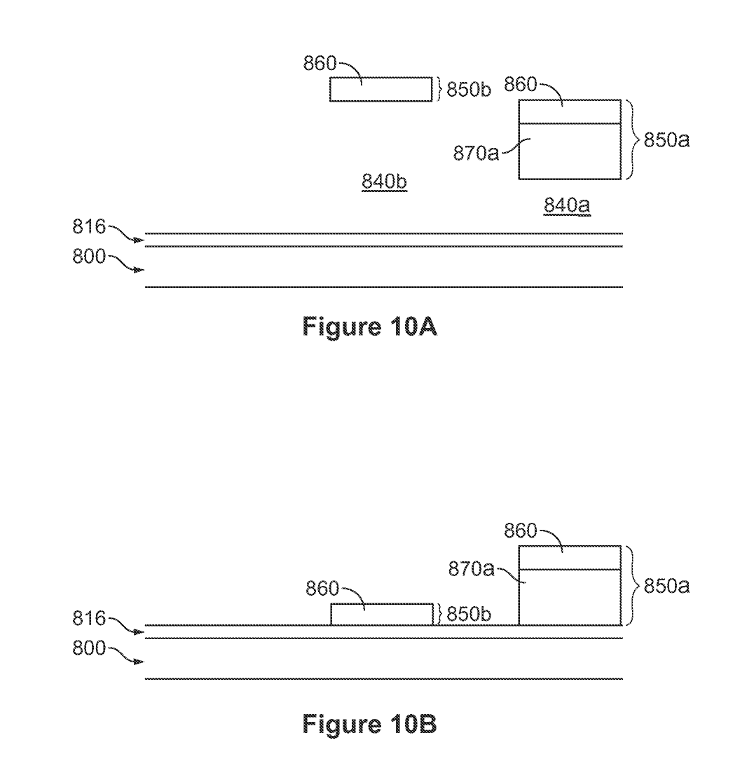

A person having ordinary skill in the art will also readily understand that the present disclosure applies to electromechanical systems with any number of different device types. FIGS. 10A and 10B illustrate one implementation of an electromechanical device array having only two different electromechanical device types, each with a different gap size. FIG. 10A illustrates the devices in the open state, while FIG. 10B illustrates the devices in the collapsed state. FIGS. 10A and 10B are similar to FIGS. 8A and 8B, respectively, with the omission of one electromechanical device type, and similar parts are referred to by like reference numerals.

FIG. 10A shows an example of a schematic cross-section of two different electromechanical device types with both shown in the open state having different sized air gaps and stiffening layers of different thickness. In the illustrated implementation, an electromechanical system device includes a substrate 800 on which two different types of electromechanical structures are formed. The different electromechanical structures each include a stationary electrode 816 and a movable electrode 850a or 850b. The movable electrode 850a can include a primary mechanical layer 860 and a mechanical sub-layer 870a. Conversely, the movable electrode 850b can include only a primary mechanical layer 860, with no mechanical sub-layer.

FIG. 10B shows an example of a schematic cross-section of the devices of FIG. 10A in the collapsed state. As shown in the illustrated implementation, air gaps 840a and 840b are no longer present when the electromechanical devices are in the collapsed or actuated state. While both electromechanical device types are shown in the collapsed state, a person having ordinary skill in the art will readily understand that the air gaps 840a and 840b can be independently opened and collapsed in any combination.

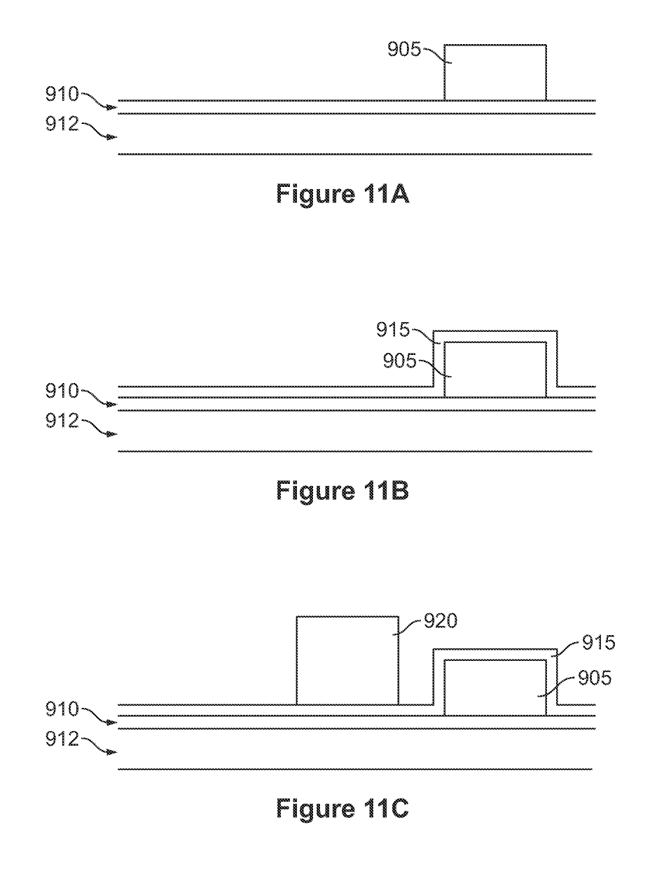

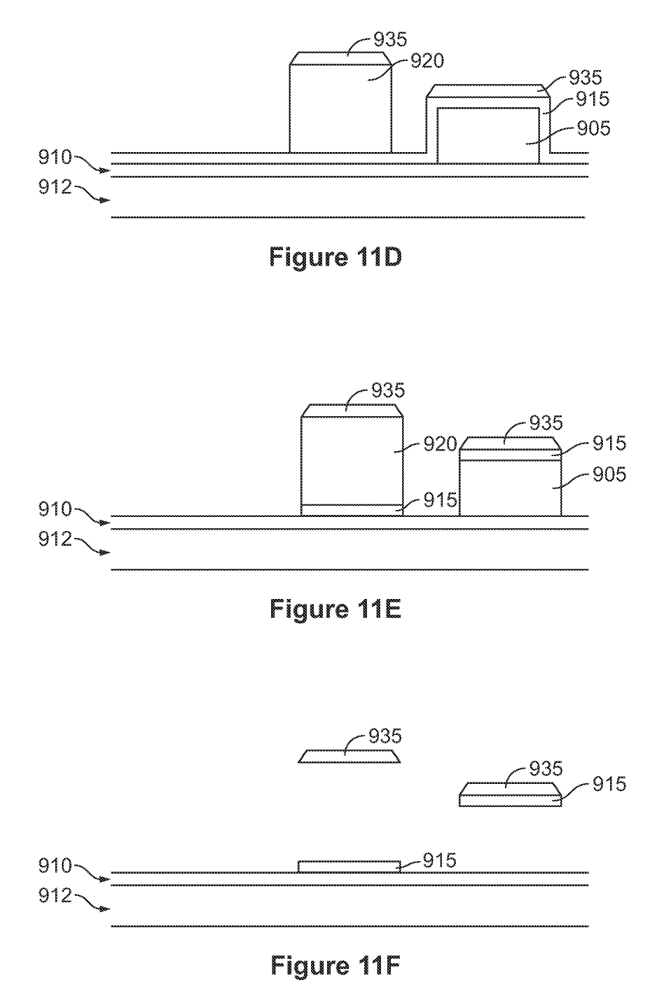

FIGS. 11A-11F show examples of schematic cross-sections illustrating an electromechanical device fabrication process including etch stops that remain as part of the electromechanical device, for two different electromechanical device types. In the illustrated sequence, two different types of electromechanical systems structures are formed, each having a different size air gap and different movable electrode thicknesses. FIGS. 11A-11F are similar to FIGS. 9A-9H, with the omission of one electromechanical device type, and similar parts are referred to by like reference numerals. Accordingly, the second stiffening layer 925 and the third sacrificial layer 930 are omitted.

Referring to FIG. 11A, a first sacrificial layer 905 is formed over a stationary electrode 910 over a substrate 912. Referring to FIG. 11B, a first stiffening layer 915 over the first sacrificial layer 905 is deposited over the stationary electrode 910. Referring to FIG. 11C, subsequently, a second sacrificial layer 920 is formed over the first stiffening layer 915. Subsequently, in FIG. 11D, a primary mechanical layer 935 is formed and patterned over each of the two sacrificial layers 905 and 920 to define two different types of unreleased electromechanical structures.

Referring now to FIG. 11E, sidewall portions of the sacrificial layers 905 and 920 and the stiffening layer 915 is removed from the areas between the two electromechanical structures. Removal of the sidewalls and stiffening layer 915 can be accomplished in substantially the same manner as described above with respect to FIG. 9G. Subsequently, in FIG. 11F, the sacrificial layers 905 and 920 are selectively removed using the release etch described above with respect to FIG. 9H.

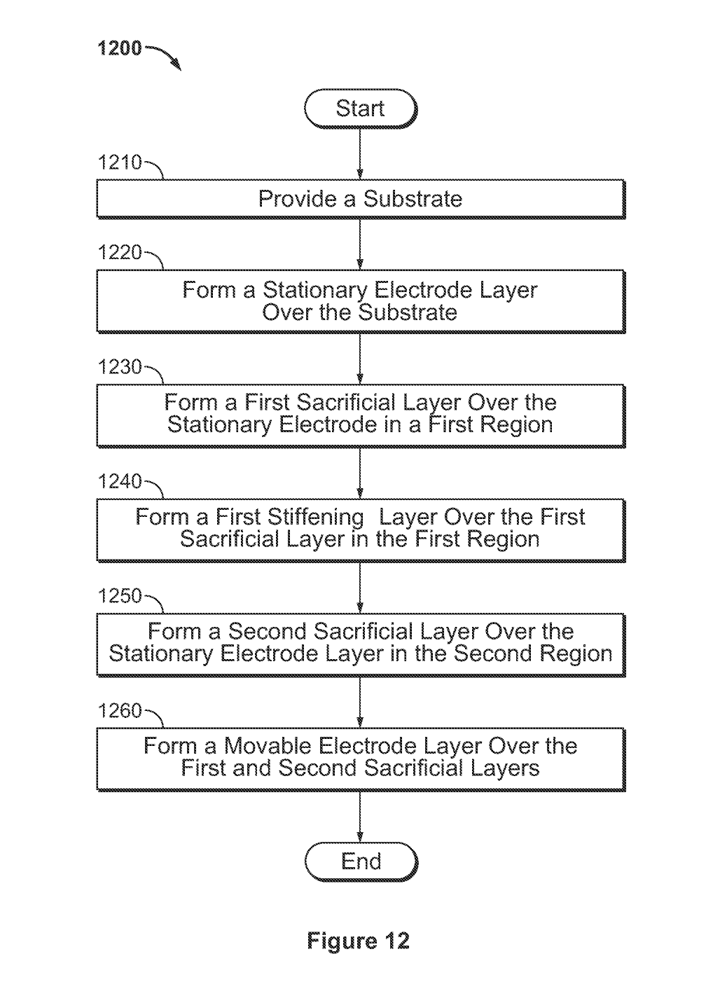

FIG. 12 shows an example of a flow chart illustrating a process of fabricating different electromechanical device types with different sacrificial layer thicknesses. In the illustrated implementation, a manufacturing process 1200 fabricates an electromechanical device corresponding to the cross-sectional schematic illustrations of FIGS. 11A-11D. In some implementations, the manufacturing process 1200 can be implemented to manufacture, e.g., interferometric modulators of the general type illustrated in FIGS. 1 and 5A-5E, in addition to other blocks not shown in FIG. 12. With reference to FIG. 12, the process 1200 begins at block 1210 with the provision of a substrate. The process 1200 continues at block 1220 with the formation of a stationary electrode layer over the substrate. Next, the process 1200 continues at block 1230 with the formation of the first sacrificial layer over the stationary electrode in a first region. Then, the process 1200 continues at block 1240 with the formation of a first stiffening layer over the first sacrificial layer in the first region. Subsequently, the process 1200 continues at block 1250 with the formation of a second sacrificial layer over the stationary electrode layer in the second region. The process 1200 continues at block 1260 with the formation of a movable electrode layer over the first and second sacrificial layers, respectively.

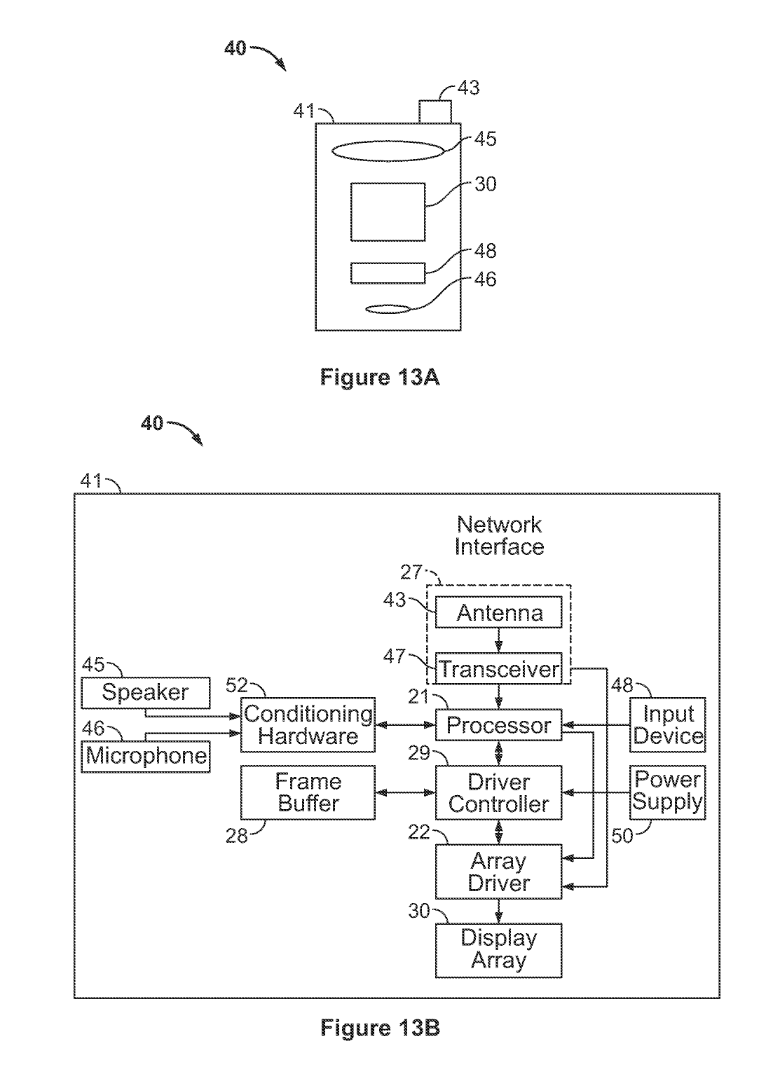

FIGS. 13A and 13B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 13B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithms described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical system comprising:
a substrate; and
a plurality of electromechanical devices, each electromechanical device comprising:
a stationary electrode;
a movable electrode; and
a collapsible gap defined between the movable electrode and the stationary electrode, the gap defining at least open and collapsed states;
wherein the electromechanical devices include at least two electromechanical device types having different gap sizes when in the open state, and the movable electrode for at least two of the electromechanical device types includes one or more mechanical sub-layers facing the gap, the cumulative thickness of the mechanical sub-layers being different for each of the at least two electromechanical device types.

2. The electromechanical system of claim 1, wherein the one or more mechanical sub-layers of each of the at least two electromechanical device types include one or more etch stop layers.

3. The electromechanical system of claim 1, wherein the one or more mechanical sub-layers of each of the at least two electromechanical device types include aluminum oxide.

4. The electromechanical system of claim 1, wherein the stationary electrode of each of the at least two electromechanical device types includes one or more optical layers facing the gap, the cumulative thickness of the optical layers being different for each of the at least two electromechanical device types.

5. The electromechanical system of claim 4, wherein the cumulative thickness of the one or more mechanical sub-layers and the optical layers is constant for each of the electromechanical device types.

6. The electromechanical system of claim 5, wherein the one or more optical layers of each of the at least two electromechanical device types include the same material as the one or more mechanical sub-layers.

7. The electromechanical system of claim 1, wherein the at least two electromechanical device types comprise:
a first electromechanical device type having a first gap size when in the open state; and
a second electromechanical device type having a second gap size when in the open state, the second gap size being larger than the first gap size,
wherein the cumulative thickness of the one or more mechanical sub-layers for the first electromechanical device type is greater than the cumulative thickness of the one or more mechanical sub-layers for the second electromechanical device type.

8. The electromechanical system of claim 7, wherein:
the one or more mechanical sub-layers for the first electromechanical device type and the movable electrode for the first electromechanical device type form a mechanical layer for the first electromechanical device type having a first stiffness; and
the one or more mechanical sub-layers for the second electromechanical device type and the movable electrode for the second electromechanical device type form a mechanical layer for the second electromechanical device type having a second stiffness, the first stiffness being greater than the second stiffness.

9. The electromechanical system of claim 1, further comprising at least one electromechanical device type without a mechanical sub-layer.

10. The electromechanical system of claim 1, wherein each electromechanical device includes an interferometric modulator.

11. The electromechanical system of claim 1, wherein the at least two electromechanical device types includes an interferometric modulator configured to reflect red light when in the open state, an interferometric modulator configured to reflect blue light when in the open state, and an interferometric modulator configured to reflect green light when in the open state.

12. The electromechanical system of claim 1, further comprising:
a display including one or more electromechanical system;
a processor that is configured to communicate with the display, the processor being configured to process image data; and
a memory device that is configured to communicate with the processor.

13. The electromechanical system of claim 12, further comprising:
a driver circuit configured to send at least one signal to the display.

14. The electromechanical system of claim 13, further comprising:
a controller configured to send at least a portion of the image data to the driver circuit.

15. The electromechanical system of claim 12, further comprising:
an image source module configured to send the image data to the processor.

16. The electromechanical system of claim 15, wherein the image source module includes at least one of a receiver, transceiver, and transmitter.

17. The electromechanical system of claim 12, further comprising:
an input device configured to receive input data and to communicate the input data to the processor.

18. A method of manufacturing at least a first electromechanical device and a second electromechanical device, in a first region and a second region, respectively, the method including:
providing a substrate;
forming a stationary electrode layer over the substrate;
forming a first sacrificial layer over the stationary electrode layer in the first region;
forming a first stiffening layer over the first sacrificial layer in the first region;
forming a second sacrificial layer over the stationary electrode layer in the second region, the second sacrificial having a different thickness than that of the first sacrificial layer; and
forming a movable electrode layer over the first and second sacrificial layers, respectively.

19. The method of claim 18, further comprising:
forming a second stiffening layer over the first stiffening layer in the first region and over the second sacrificial layer in the second region; and
forming a third sacrificial layer over the stationary electrode layer in a third region, the third sacrificial layer having a different thickness than that of the first and second sacrificial layers;
wherein forming the movable electrode layer further includes forming the movable electrode layer over the third sacrificial layer.

20. The method of claim 19, further comprising using each of the first and second stiffening layers as etch stops in forming at least one subsequently formed layer.

21. The method of claim 19, wherein forming the movable electrode layer includes:
forming the movable electrode layer on the second stiffening layer in the first region, wherein the movable electrode layer, the first stiffening layer, and the second stiffening layer form a first mechanical layer in the first region;
forming the movable electrode layer on the second stiffening layer in the second region, wherein the movable electrode layer and the second stiffening layer form a second mechanical layer in the second region; and
forming the movable electrode layer on the third sacrificial layer in the third region, wherein the movable electrode layer forms a third mechanical layer in the third region.

22. The method of claim 21, further comprising:
forming the first stiffening layer over the stationary electrode in the second and third regions; and
forming the second stiffening layer over the second sacrificial layer in the second region, and over the first stiffening layer in the third region.

23. The method of claim 22, wherein:
forming the second sacrificial layer includes forming the second sacrificial layer over the first stiffening layer in the second region; and
forming the third sacrificial layer includes forming the third sacrificial layer over the second stiffening layer in the third region.

24. The method of claim 21, wherein the second sacrificial layer is thicker than the first sacrificial layer and the third sacrificial layer is thicker than the second sacrificial layer.

25. The method of claim 24, wherein:
the second mechanical layer in the second region is less stiff than the first mechanical layer in the first region; and
the third mechanical layer in the third region is less stiff than the second mechanical layer in the second region.

26. The method of claim 19, wherein a third electromechanical device is formed in the third region, and wherein each of the first, second and third electromechanical devices include an interferometric modulator.

27. The method of claim 26, wherein the first, second, and third electromechanical devices include interferometric modulators configured to reflect green light, red light, and blue light, respectively in an open state.

28. An electromechanical system comprising at least a first electromechanical device and a second electromechanical device, the electromechanical system comprising:
means for supporting the first and second electromechanical devices;
means for defining a first gap for the first electromechanical device;
means for defining a second gap for the second electromechanical device, the second gap having a different size than the first gap;
means for selectively collapsing and opening the first gap for the first electromechanical device;
means for selectively collapsing and opening the second gap for the second electromechanical device;
first stiffening means for stiffening the means for selectively collapsing and opening the first gap, the first stiffening means facing the first gap; and
second stiffening means for stiffening the means for selectively collapsing and opening the second gap, the second stiffening means facing the second gap and providing a different stiffness from the first stiffening means.

29. The electromechanical system of claim 28, wherein the each of the means for selectively collapsing and opening the first and second gaps includes a first electrode and a second electrode on opposite sides of the respective gap.

30. The electromechanical system of claim 29, further comprising:
first etch stop means on the first electrode of the means for selectively collapsing and opening the first gap; and
second etch stop means on the first electrode of the means for selectively collapsing and opening the second gap,
wherein the first electrode of the means for selectively collapsing and opening the first gap is positioned under the second electrode of the means for selectively collapsing and opening the first gap; and
wherein the first electrode of the means for selectively collapsing and opening the second gap is positioned under the second electrode of the means for selectively collapsing and opening the second gap.

31. The electromechanical system of claim 28, wherein the second gap is bigger than the first gap and wherein the second stiffening means provides a stiffness greater than the first stiffening means.

32. The electromechanical system of claim 31, wherein:
the first etch stop means on the first electrode of the means for selectively collapsing and opening the first gap includes the same material as the first stiffening means; and
the second etch stop means on the first electrode of the means for selectively collapsing and opening the second gap includes the same material as the second stiffening means.

33. The electromechanical system of claim 32, wherein the first etch stop means has a different thickness than the second etch stop means.

34. The electromechanical system of claim 28, wherein the means for defining the first gap includes one or more support structures adjacent the first gap, and wherein the means for defining the second gap includes one or more support structures adjacent the second gap.

35. The electromechanical system of claim 28, wherein the first stiffening means includes one or more dielectric layers and wherein the second stiffening means includes one or more dielectric layers, the second stiffening means including a different number of dielectric layers than the first stiffening means.

36. The electromechanical system of claim 35, wherein the one or more dielectric layers include aluminum oxide.
